(19) United States
(12) Patent Application Publication
(10) Pub. No.: US 2025/0333602 A1
(43) Pub. Date: Oct. 30, 2025

(54) Plastic Composite Component for a Motor Vehicle, and Motor Vehicle

(71) Applicant: Bayerische Motoren Werke Aktiengesellschaft, Muenchen (DE)

(72) Inventor: Gerd KURTH, Muenchen (DE)

(21) Appl. No.: 18/855,359

(22) PCT Filed: Jun. 1, 2023
(86) PCT No.: PCT/EP2023/064678

§ 371 Date: Oct. 9, 2024

(30) Foreign Application Priority Data
Jun. 29, 2022 (DE) 10 2022 116 283.4

(51) Int. Cl. C08L 97/02; C08L 23/06; C08L 23/12; C08L 63/00; C08L 75/04

(52) U.S. Cl. CPC C08L 97/02; C08L 23/06; C08L 23/12; C08L 63/00; C08L 75/04; C08L 2203/30; C08L 2205/16; C08L 2207/20

(57) ABSTRACT

A plastic composite component for a motor vehicle has a molded body including a plastic compound that contains natural particles. At least some of the natural particles are dyed in a shade of color different from a natural color of the natural particles, and the plastic compound is designed such that the particles are visible. Also disclosed is a motor vehicle including a plastic composite component of this type.

### BACKGROUND AND SUMMARY

The invention relates to a plastic composite component for a motor vehicle and to a motor vehicle comprising at least one such plastic composite component.

Plastic components for motor vehicles are usually colored throughout with pigments and/or provided with additional paint finishes to obtain a preferably monochrome product.

Also known are plastic or polymer composite components which have a look involving optical fibers and in the case of which a fibrous material is incorporated in a transparent or translucent plastic matrix, so that the fibers can still be seen visually.

Sustainable motor vehicles are a theme which greatly occupies the vehicle industry. A wide variety of attempts have been made to increase the proportion of natural materials in motor vehicles and thus reduce the CO₂ consumption per vehicle and act sustainably. Document DE 10 2011 056 933 A1 discloses for example an interior component for a motor vehicle that has a top layer consisting of a fluid-jet-bonded natural fiber web material.

At the same time, there is a trend of customers at the high end of the market desiring the surfaces to have a particularly high-quality look.

Against this background, an object of this disclosure is to specify an option for how to produce a vehicle component more sustainably than before and, in so doing, offer a wide variety of design options. In a further aspect, the surface should give a particularly high-quality impression.

The object may be achieved by a plastic composite component according to the independent claim and a motor vehicle according to a dependent claim. Further advantageous embodiments emerge from the dependent claims and from the following description.

What is specified is a plastic composite component for a motor vehicle, comprising a molded body comprising a plastic compound in which natural particles are embedded, wherein at least one portion of the natural particles is provided with a color which is different from the natural color of the natural particles and the natural particles are visible within the plastic compound.

In this respect, the technology utilizes the fact that many natural particles can be colored such that the color is absorbed into the particles, as a result of which a good color saturation is achieved on the one hand and, on the other hand, the fibers or surface structure of the natural particles remain as they were. Since the natural particles originally do not have a coloring of even appearance, this unevenness can be also maintained in the colored state. It is possible to create a colored “cloudy look.” Consequently, the natural appearance of the natural particles is expanded in scope in terms of its optical design by a multiplicity of possible color variations. The use of natural fibers minimizes the use of material and the weight by up to 50% in relation to conventional materials such as plastic. Moreover, natural materials have a good CO₂ balance, since during their growth phase they take up carbon dioxide and give off oxygen.

The motor vehicle component has a visible side, which is the side visible to the viewer, or the vehicle occupants, in the installed state. The look of the plastic compound involves visible particles, which means that the natural particles embedded in the plastic compound are at least partially visible at least on the visible side. For this, the plastic compound may be for example transparent or translucent in various colors. The plastic compound contains at least one plastic or polymer, with which fillers, stabilizers (UV stabilizers or others), reinforcing materials and/or other additives may be additionally admixed. Through compounding, the properties of the plastic(s) are modified for the respective application. The plastic compound is preferably UV-resistant. The plastic compound may be in the form of a thermosetting plastic system or thermoplastic system. The use of thermosetting plastics, such as epoxy resin-based or polyurethane (PUR)-based systems, is advantageous in particular, because only low process temperatures are necessary, as a result of which the natural particles are subjected to hardly any thermal stress and the look that can be achieved is improved. From this perspective, it is similarly advantageous if use is made of thermoplastic systems with low processing temperatures, such as systems based on polypropylene or based on polyethylene.

The molded body substantially defines the outer dimensions and stability of the plastic composite component. The plastic composite component may also comprise, for example, fastening means such as clips, which are fastened to or in or integrally molded on the molded body.

To obtain a multicolored pattern, in one embodiment it may be advantageous if a first portion of the natural particles is provided with a first color and at least one further portion of the natural particles is provided with a further color different than the first color. For example, the first portion may be provided with a blue color and a further portion may be provided with a gray color. The use of complementary colors makes it possible to obtain particular color effects. Of course the choice of color is not restricted to two colors. It is possible to combine three or more colors in the component by coloring a respective corresponding proportion of the natural particles. In addition, it is possible to color the plastic compound itself, in order to thus vary for example the basic color of the component. By virtue of the multicolored configuration, it may be possible to obtain novel color effects on vehicle components and it may be possible to comply with a customer's desires in terms of customization.

In one embodiment, the visible side of the plastics composite component has a cloudy or mottled patterning. A cloudy patterning may be produced when natural particles are colored with a non-opaque color, such that the surface of the natural particles is not opaquely covered; instead, the original surface structure can still be seen and although the natural differences in brightness in the surface are modified in terms of color, they fundamentally remain. Such a patterning can be achieved, for example, in the case of use of a non-opaque glaze. Hand-made papers or parchment inherently have, for example, a cloudy patterning. To produce a mottled patterning, the basic color is irregularly interspersed with at least one further color. One skilled in the art may select the type and size of the natural particles, the proportions by weight of the natural particles in the plastic compound, and the color in order to arrive at a desired result. For example, a mottled colored pattern may be produced by using a plastic compound based on polypropylene with a wood proportion of 30% by weight, wherein each 10% by weight of the wood proportions is added in a different color (for example 10% by weight dark blue+10% by weight gray+10% by weight light blue in a matrix of polypropylene natural colors). Of course, other percentage distributions are conceivable. Surprisingly, it has been found that a cloudy patterning, or a mottled patterning, is particularly resistant to damage. It is very difficult to visually see superficial scratches and they scarcely adversely affect the appearance of the composite component.

The natural particles may be present in different shapes and sizes. The natural particles may be present in the form of flakes. It is particularly preferable if the natural particles in one embodiment are present in the form of natural fibers and in particular in the form of plant-based natural fibers. The natural fibers are flexible structures which are thin relative to their length and preferably have a ratio of length to diameter of more than 10 to 1. The fibers may also be present in the form of fiber bundles and may be processed in the component. The fiber structure allows a very fine distribution and coloring of the molded body and is advantageous in particular if a cloudy or mottled look is desired. If the natural fibers are to be present in the molded body in the form of short or long fibers in disordered form, it is advantageous if the natural fibers are mixed into the plastic compound already before the plastic composite component is produced.

One embodiment provides that the natural fibers are introduced into the molded body in the form of a semi-finished textile product. The semi-finished textile product may be a flat textile, such as a woven fabric, braided fabric or nonwoven, which is produced before the motor vehicle component is produced. The semi-finished textile product may, for example, be overmolded with the plastic compound in an injection mold, as a result of which it is incorporated into the molded body.

All textile fibers and fibrous materials obtained from plant-based and/or animal-based material can be used as the natural fibers. Particularly preferred are plant-based natural fibers comprising cotton, basalt, flax, jute, hemp, kenaf, sisal, abaca, coconut, wood and/or viscose.

In one embodiment, the sustainability of the plastic composite component may be further increased in that the plastic compound may be based on a non-petroleum-based plastic or contains a non-petroleum-based plastic. Such plastics may be obtained for example from plant-based oils or fats.

In a preferred embodiment, the sustainability of the plastic composite component may be further increased in that the plastic compound may contain recycled plastic material. The recycled plastic material may be obtained from plastic waste and processed to form recyclate, for example, in the form of granules. This recyclate may then be admixed proportionally during the production of the plastic compound, and the proportion can vary depending on requirements. The plastic compound then contains both virgin plastic and recycled plastic. It is thus possible, for example, to allow post-consumer recyclate, such as plastic from old vehicles, into the production of new vehicles.

In particular the cloudy or mottled patterning of the molded body makes it possible to dispense with a protective top layer on the molding. The visible surface is the surface of the visible side of the vehicle component. By coloring the natural particles, the colored effect is created not just on the surface (as would be the case with a finish), but down to a certain depth in the molded body. As a result, minor surface damage, such as scratches, do not change the patterning and can thus scarcely be seen by the viewer. In particular, in one embodiment it is therefore possible to dispense with a clear finish or PUR top layer and a surface of the molded body forms a visible surface of the plastic composite component, which does not have a top layer.

For particularly economical production, the plastic composite component may preferably be produced by injection molding. The natural particles may be incorporated in particular in the injection molding compound and injected into the injection mold. As an alternative, it is also possible to place the natural particles into the injection mold as semi-finished products and to overmold them.

The plastic composite component for a motor vehicle is preferably an interior component, such as a paneling or trim component or a decorative strip. For example, it may be a seat trim or door paneling, a door sill strip, or a cladding for a vehicle pillar.

The plastics composite component may alternatively be an exterior component for a motor vehicle, such as a bumper fascia, a mirror cap, an insert in a bumper fascia, a diffusor plate or a sill trim.

Also specified is a motor vehicle comprising a plastic composite component as described above. By using one or more of the plastic composite components according to this disclosure in a motor vehicle, the technical advantages described may also be obtained for the motor vehicle.

The technology offers a new approach for the sustainable design of customized plastic composite components with an exceptional optical effect. Optical effects as known to date only from the field of floor coverings for buildings can be implemented particularly well. In particular, in the case of plastic composite components designed in three or more colors, there is the option to reduce variants, since a component can be produced such that its color matches multiple equipment variants.

Features and details that are described in connection with the vehicle component also apply in connection with the motor vehicle, and vice versa, and therefore, with respect to the disclosure, reference is or can be always interchangeably made to the individual aspects of the invention.

Further advantages, features and details of the technology emerge from the following description, which describes exemplary embodiments of the invention in detail with reference to the drawings. The features mentioned in the claims and in the description can each be essential to the invention individually per se or in any desired combination. If the term “can” or “may” is used in this application, it means both a technical possibility and the actual technical implementation.

Exemplary embodiments are explained below with reference to the appended drawings.

### BRIEF DESCRIPTION OF THE DRAWINGS

In the drawings, which provide schematic illustrations:

FIG. 1 shows a plan view of an exemplary plastic composite component with cloudy patterning;

FIG. 2 shows a sectional view of the plastic composite component from FIG. 1;

FIG. 3 shows a plan view of an exemplary plastic composite component with mottled patterning;

FIG. 4 shows a sectional view of the plastic composite component from FIG. 4; and

FIG. 5 shows an exemplary motor vehicle comprising exemplary plastic composite components.

### DETAILED DESCRIPTION OF THE DRAWINGS

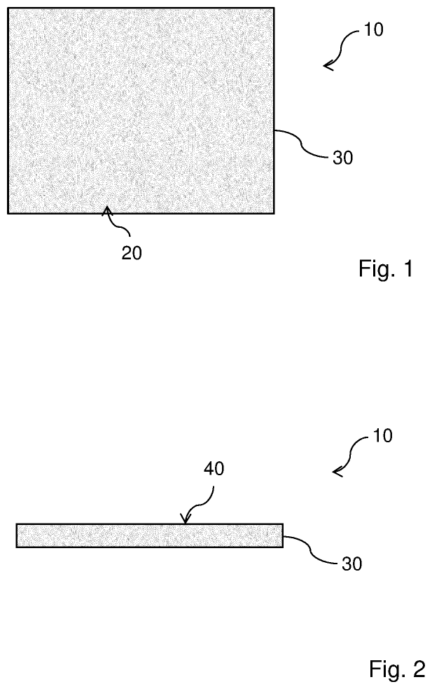

FIG. 1 shows an exemplary plastic composite component 10 with a cloudy patterning of the visible side 20. The plastic composite component 10 comprises a molded body 30 made of a plastic compound, into which natural particles in the form of wood fibers are mixed. A first portion of the wood fibers is provided with a first color, a second portion of the wood fibers is provided with a second color. The plastic of the plastic compound may be natural-colored polypropylene. This produces the cloudy patterning in three matching colors. FIG. 1 and FIG. 2 show this in white, gray and black for clearer illustration. In principle, any color combination can be selected.

FIG. 2 shows the plastic composite component 10 in a sectional view. By admixing the natural particles in the plastic compound, the cloudy look is achieved throughout the molded body 30, with the result that superficial scratches or damage can scarcely be visually seen. In this embodiment, a top layer is omitted, with the result that the molded body simultaneously forms the visible surface 40 of the plastic composite component 10.

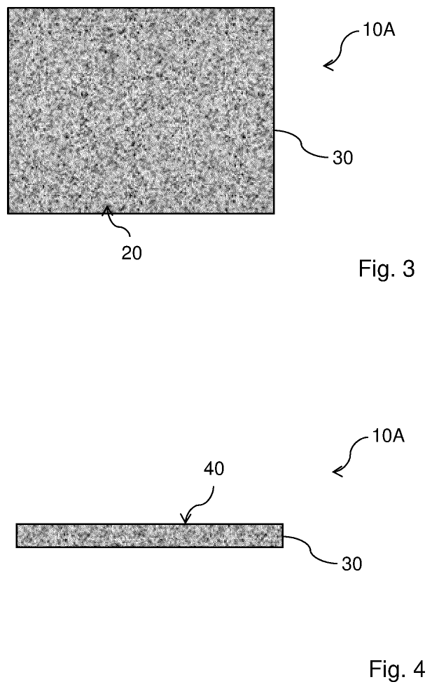

FIGS. 3 and 4 show a further exemplary plastic composite component 10A. It differs from the plastic composite component 10 only by the patterning obtained. In this respect, the same reference signs denote the same features and are not explained again. The plastic composite component 10A has a mottled patterning, which is achieved by adding correspondingly colored natural particles to the plastic compound.

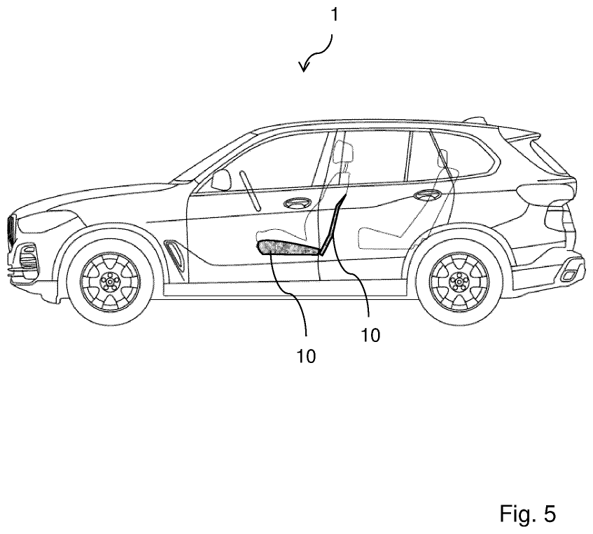

FIG. 5 shows an exemplary motor vehicle 1 in which two plastic composite components 10 and 10 with cloudy patterning in the form of seat trim components are installed. The plastic composite components could similarly have a mottled patterning. Such artistic composite components could also be mounted on the vehicle in the form of exterior components, such as a mirror cap or the like.

The plastic compound is preferably a thermoplastic system based on polypropylene or polyethylene or a thermosetting plastic system.

List of reference signs

| | |
|---|---|
| 1 | Motor vehicle |
| 10, 10A | Plastic composite component |
| 20 | Visible side |
| 30 | Molded body |
| 40 | Visible surface |

1-13. (canceled)

14. A plastic composite component for a motor vehicle, the plastic composite component comprising:
a molded body comprising a plastic compound including natural particles, wherein
at least one portion of the natural particles is provided with a color different from a natural color of the natural particles, and
the natural particles are visible within the plastic compound.

15. The plastic composite component according to claim 14, wherein
the plastic compound comprises a thermosetting plastic system or a thermoplastic system.

16. The plastic composite component according to claim 15, wherein
the thermosetting plastic system comprises epoxy or polyurethane.

17. The plastic composite component according to claim 15, wherein
the thermoplastic system comprises polyethylene or polypropylene.

18. The plastic composite component according to claim 14, wherein
a first portion of the natural particles is provided with a first color, and
at least one further portion of the natural particles is provided with a further color different than the first color.

19. The plastic composite component according to claim 14, wherein
a visible side of the plastic composite component has a cloudy or mottled patterning.

20. The plastic composite component according to claim 14, wherein
the natural particles comprise natural fibers.

21. The plastic composite component according to claim 14, wherein
the natural fibers are introduced into the molded body in a form of a semi-finished textile product.

22. The plastic composite component according to claim 14, wherein
the natural fibers comprise cotton, basalt, flax, jute, hemp, kenaf, sisal, abaca, coconut and/or viscose.

23. The plastic composite component according to claim 14, wherein
the plastic compound comprises a non-petroleum-based plastic.

24. The plastic composite component according to claim 14, wherein
the plastic compound contains recycled plastic material.

25. The plastic composite component according to claim 14, wherein
a surface of the molded body forms a visible surface of the plastic composite component.

26. The plastic composite component according to claim 25, wherein the surface of the molded body does not further comprise a top layer.

27. The plastic composite component according to claim 14 being produced by injection molding.

28. The plastic composite component according to claim 14 being an interior component or an exterior component.

29. A motor vehicle comprising the plastic composite component according to claim 14.
